(19) United States
(12) Patent Application Publication
(10) Pub. No.: US 2026/0222981 A1
(43) Pub. Date: Jul. 30, 2026

(54) METHOD AND APPARATUS FOR PLMN SELECTION IN WIRELESS COMMUNICATION SYSTEM

(71) Applicant: Samsung Electronics Co., Ltd., Suwon-si, Gyeonggi-do (KR)

(72) Inventors: Lalith KUMAR, Bangalore (IN); Danish Ehsan HASHMI, Bangalore (IN); Koustav ROY, Bangalore (IN); Jagadeesh GANDIKOTA, Bangalore (IN)

(21) Appl. No.: 19/146,131

(22) PCT Filed: Jan. 5, 2024
(86) PCT No.: PCT/KR2024/000303

§ 371 Date: Jul. 7, 2025

(30) Foreign Application Priority Data
Jan. 5, 2023 (IN) 202341001217
Jan. 17, 2023 (IN) 202341003400
Dec. 20, 2023 (IN) 202341001217

(51) Int. Cl. H04W 48/18; H04W 48/16; H04W 84/04

(52) U.S. Cl. CPC H04W 48/18; H04W 48/16; H04W 84/042

(57) ABSTRACT

Embodiments herein disclose a method for handling a PLMN selection in a wireless network by a UE. The method includes receiving, by a user equipment (UE), slice-based PLMN selection information from a network entity of a home public land mobile network (HPLMN), and selecting, by the UE, a visited public land mobile network (VPLMN) among a plurality of PLMNs based on a priority order defined in the slice-based PLMN selection information.

### CROSS-REFERENCE TO RELATED APPLICATION(S)

This application is a U.S. National Stage application under 35 U.S.C. § 371 of an International application number PCT/KR2024/000303, filed on Jan. 5, 2024, which is based on and claims priority of an Indian Patent Application number 202341001217, filed on Jan. 5, 2023, in the Indian Intellectual Property Office, of an Indian Patent Application number 202341003400, filed on Jan. 17, 2023, in the Indian Intellectual Property Office, and of an Indian Patent Application number 202341001217, filed on Dec. 20, 2023, in the Indian Intellectual Property Office, the disclosure of each of which is incorporated by reference herein in its entirety.

### TECHNICAL FIELD

Embodiments disclosed herein relate to wireless communication networks, and more particularly to a method and apparatus for selecting a Public Land Mobile Network (PLMN) in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to help the reader to understand the present invention. Applicants have made no determination and make no assertion as to whether any of the above might be applicable as prior art with regard to the present application.

### DISCLOSURE OF INVENTION

### Technical Problem

The present disclosure provides a method and an apparatus for performing PLMN selection efficiently in a wireless communication system.

### Solution to Problem

The aspect of the embodiments herein is to disclose an enhanced slice aware SOR information (called as Slice-based PLMN selection information) provided to a UE by a HPLMN (i.e. UDM node) based on UE subscription (i.e. based on subscription of the UE). Using the slice-based PLMN selection information, the UE selects a VPLMN which supports required S-NSSAI. The UE selects the PLMN/SNPN to register on that selected network.

Another aspect of the embodiments herein is to disclose methods and a UE for performing assisted PLMN selection, where the network can provide more granularity as a part of enhanced slice aware SoR information.

Another aspect of the embodiments herein is to disclose methods and the UE for performing assisted PLMN selection, where the UE considers a HPLMN search if all required slices are supported in other PLMNs.

Another aspect of the embodiments herein is to disclose methods and the UE for performing assisted PLMN selection, wherein a home PLMN will always be considered as higher priority PLMN irrespective of slice support.

Another aspect of the embodiments herein is to perform the PLMN search, wherein a slice aware SoR information update triggers a PLMN search.

Another aspect of the embodiments herein is to perform the PLMN search, where the PLMN search is triggered based on a change of S-NSSAI requirement

Another aspect of the embodiments herein is to perform the PLMN search, where availability of other access types is considered during a PLMN search.

Another aspect of the embodiments herein is to disclose perform the PLMN search, where the PLMN search is triggered based on other access type 5GMM DEREGISTERED NO-CELL-AVAILABLE or 5GMM-REGSITERED.NO-CELL AVAILABLE state.

Accordingly, the embodiments herein provide a method for a public land mobile network (PLMN) selection in a wireless network, the method comprises receiving, by a user equipment (UE), slice-based PLMN selection information from a network entity of a home public land mobile network (HPLMN), and selecting, by the UE, a visited public land mobile network (VPLMN) among a plurality of PLMNs based on a priority order defined in the slice-based PLMN selection information.

Accordingly, the embodiments herein provide a user equipment (UE) in a wireless network, comprises a transceiver, and at least one processor configured to receive, through the transceiver, slice-based PLMN selection information from a network entity of a home public land mobile network (HPLMN), and select a visited public land mobile network (VPLMN) among a plurality of PLMNs based on a priority order defined in the slice-based PLMN selection information.

Accordingly, the embodiments herein provide a method for handling a PLMN selection in a wireless network. The method includes receiving, by a UE, a slice aware SoR information from a network entity. Further, the method includes determining, by the UE, a required network slice. Further, the method includes selecting, by the UE, a PLMN from a plurality of PLMNs based on a priority order defined for each PLMN from the plurality of PLMNs with respect to the determined required network slice. Further, the method includes triggering, by the UE, a registration procedure with the selected PLMN by sending a registration request message to the network entity.

Accordingly, the embodiments herein provide a UE including a PLMN selection controller coupled with a processor and a memory. The PLMN selection controller is configured to receive a slice aware SoR information from a network entity. Further, the PLMN selection controller is configured to determine a required network slice. Further, the PLMN selection controller is configured to select a PLMN from a plurality of PLMNs based on a priority order defined for each PLMN from the plurality of PLMNs with respect to the determined required network slice. Further, the PLMN selection controller is configured to trigger a registration procedure with the selected PLMN by sending a registration request message to the network entity.

In an embodiment, the slice aware SoR information includes a preferred PLMN list for specific subscribed S-NSSAI in a UE subscription. The preferred PLMN list includes at least one of: a single PLMN that is known by a Home PLMN (HPLMN) to support a Network Slice Selection Assistance Information (S-NSSAI), and a list of PLMNs in the priority order.

In an embodiment, the slice aware SoR information includes a S-NSSAI supported a list per PLMN. The PLMN is known by a HPLMN to support a S-NSSAI, and a list of S-NSSAIs in the priority order.

In an embodiment, selecting, by the UE, the PLMN from the plurality of PLMNs based on the priority order defined for each PLMN from the plurality of PLMNs with respect to the determined required network slice includes determining that the UE intends to use a S-NSSAI, where the S-NSSAI is not supported by a current registered PLMN, utilizing the slice aware SOR information configured in the UE for selecting the PLMN, and ignoring an Operator-controlled Public Land Mobile Network (OPLMN) list.

In an embodiment, each PLMN entry includes an area in which a required S-NSSAI is supported. The area includes at least one of a Tracking Area Identity (TAI), a cell-identifier (ID), and a Closed Access Group ID (CAG-ID).

In an embodiment, the UE ignores the selected PLMN when the UE is in an area where the required S-NSSAI is not supported, selects a next available priority PLMN.

In an embodiment, after a required service is executed, the UE determines to ignore the slice aware SOR information and starts using an OPLMN list to select a highest priority PLMN.

In an embodiment, the UE selects and attempt to register on the PLMN by using at least one of: an OPLMN list and a Slice aware SOR information list.

In an embodiment, the required network slice is determined by using at least one of: a prioritized S-NSSAI information, information received from an upper layer of the UE, and usage of at least one application running in the UE.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a scenario, wherein a slice aware SoR information is not sufficient to know homogeneous NSSAI support in a wireless network, according to prior arts;

FIGS. 2A and 2B illustrate a scenario, wherein a higher priority PLMN selection may stop a UE from using required S-NSSAI(s), according to prior arts;

FIGS. 3A and 3B illustrate an example scenario, where a home PLMN may not be considered as highest priority based on slice aware information, according to prior arts;

FIG. 4 illustrates a scenario, where the slice aware SoR information does not trigger the PLMN search, according to prior arts;

FIG. 5 illustrates a scenario, where a PLMN search does not consider availability of other access types, according to prior arts;

FIG. 6 illustrates a scenario, where the PLMN search does not other access types and goes to a 5GMM DEREGISTERED NO-CELL-AVAILABLE or a 5GMM-REGSITERED.NO-CELL AVAILABLE state, according to prior arts;

FIGS. 7A and 7B depict example scenarios, where the network is provided with more granularity as a part of slice aware SoR information, according to embodiments as disclosed herein;

FIGS. 8A and 8B illustrate a scenario, where the UE can consider a HPLMN search if all required slices are supported in other PLMN in the wireless network, according to embodiments as disclosed herein;

FIGS. 9A and 9B illustrate a scenario, wherein a home PLMN will always be considered as higher priority irrespective of slice support, according to embodiments as disclosed herein;

FIG. 10 illustrates a scenario, wherein a slice aware SoR information update may trigger a PLMN search, according to embodiments as disclosed herein;

FIG. 11 illustrates a scenario, where the PLMN search is triggered, on detecting a change of S-NSSAI requirement, according to embodiments as disclosed herein;

FIG. 12 illustrates a scenario, wherein the availability of other access types is considered during the PLMN search, according to embodiments as disclosed herein;

FIG. 13 illustrates an example scenario, wherein the PLMN search is triggered based on other access type 5GMM DEREGISTERED NO-CELL-AVAILABLE or 5GMM-REGSITERED.NO-CELL AVAILABLE state, according to embodiments as disclosed herein;

FIG. 14 depict an example scenario, wherein the PLMN search is triggered based on other access type 5GMM DEREGISTERED NO-CELL-AVAILABLE or 5GMM-REGSITERED.NO-CELL AVAILABLE state, according to embodiments as disclosed herein;

FIG. 15 shows various hardware components of the UE handling a PLMN selection in the wireless network, according to the embodiments as disclosed herein; and

FIG. 16 is a flow chart illustrating a method for handling a PLMN selection in a wireless network, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Enhanced Slice aware SoR (Steering of Roaming) information or Slice aware SOR information includes preferred PLMNs for specific S-NSSAIs in a UE subscription (a preferred PLMN list may be also be a single PLMN that is known by a HPLMN to support the S-NSSAI, or a list of PLMNs in preference order that differs from the order of a basic SoR information that is also provided). Along with an OPLMN list in the SoR information, the HPLMN may provide one more list where it will map each slices to a list of PLMNs. The list holds information about which PLMN is considered as priority PLMN for that particular S-NSSAI. As an example, if the list is as below, then the UE (100) considers PLMN-1 as a higher priority PLMN compared to a PLMN-2 if it wants to use S-NSSAI-1. For S-NSSAI-2, this priority will be reversed. The information assists the UE (100) to choose PLMN based on service or slice (S-NSSAIs) requirement:
a) S-NSSAI-1: PLMN-1, PLMN-2, and
b) S-NSSAI-2: PLMN-2, PLMN-1

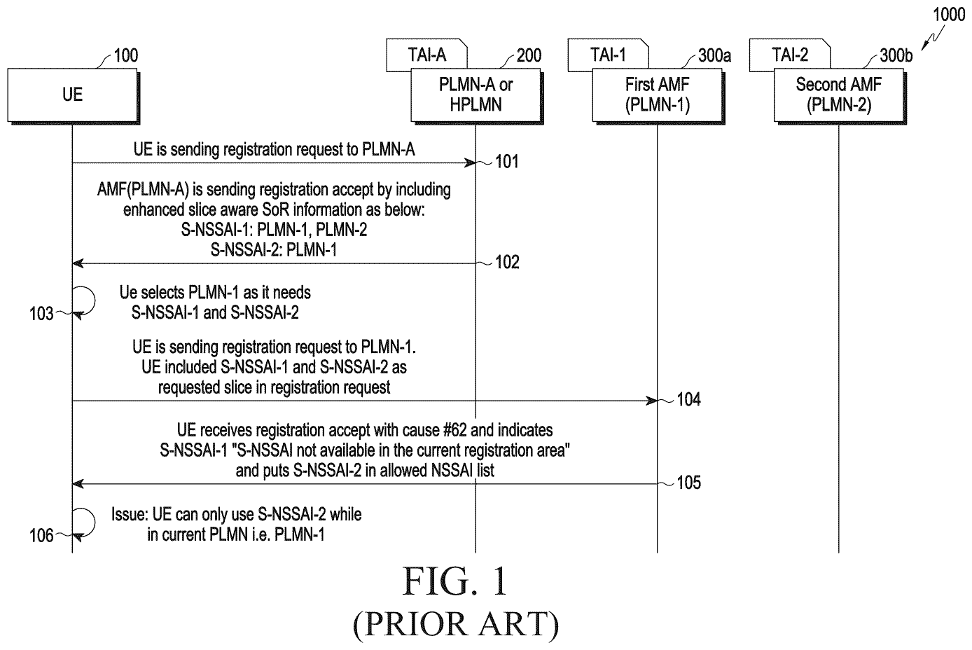

FIG. 1 illustrates a scenario, wherein the slice aware SoR information is not sufficient to know homogeneous S-NSSAI support in a wireless network (1000). In step 101, the UE (100) is sending a NAS message e.g. Registration Request to PLMN-A (200). In step 102, the AMF (or AMF node) (PLMN-A) (300) sends the NAS message e.g. registration accept by including enhanced Slice Aware SoR information as below:
a) S-NSSAI-1: PLMN-1, PLMN-2; and
b) S-NSSAI-2: PLMN-1.

In step 103, the UE (100) selects the PLMN-1 as the UE (100) intends to use both S-NSSAI-1 and S-NSSAI-2. In step 104, the UE (100) sends the NAS message e.g., registration request to the PLMN-1. The UE (100) includes S-NSSAI-1 and S-NSSAI-2 as the requested S-NSSAIs in the registration request. In step 105, the UE (100) receives the NAS message e.g. registration accept with cause #62 and indicates S-NSSAI-1 “S-NSSAI not available in a current registration area” and puts S-NSSAI-2 in allowed NSSAI list. In step 106, the UE (100) can only use S-NSSAI-2 while in current PLMN i.e. PLMN-1. It can be seen that the inclusion of the PLMN id is not enough for the UE (100) to be aware whether S-NSSAI is supported in a given area.

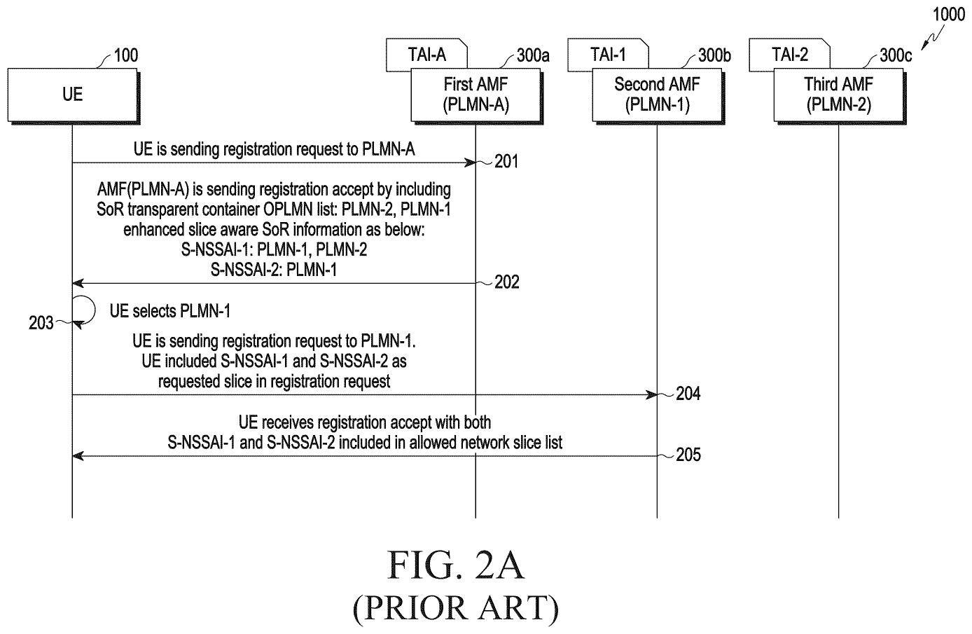

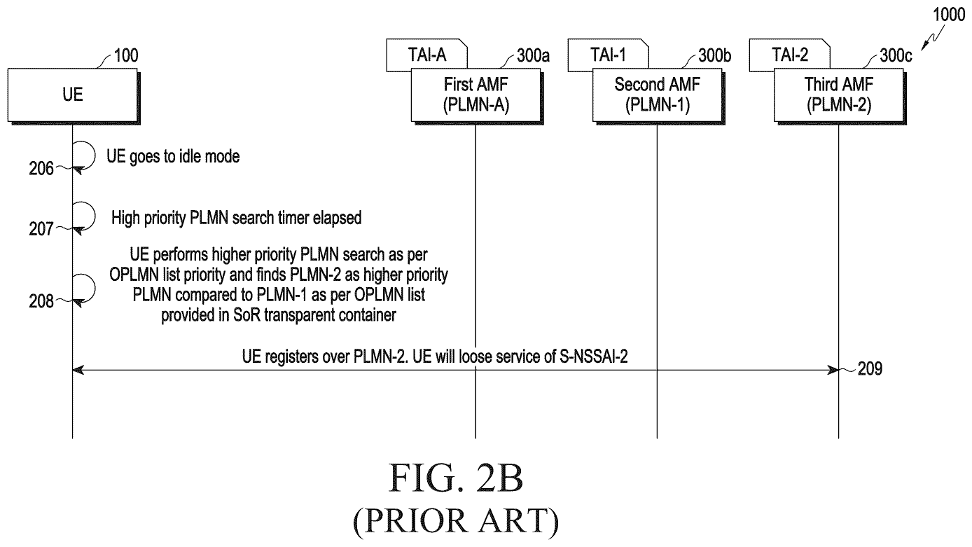

FIGS. 2A and 2B illustrate a scenario, wherein a higher priority PLMN selection may stop the UE (100) from the slice based PLMN selection. In step 201, the UE (100) sends the NAS message e.g., registration request to the PLMN-A. In step 202, the AMF (PLMN-A) (300a) sends the NAS message e.g., registration accept by including SoR Transparent Container (or any information element IE) OPLMN list: PLMN-2, PLMN-1 and Enhanced Slice Aware SoR information as below:
a) S-NSSAI-1: PLMN-1, PLMN-2, and
b) S-NSSAI-2: PLMN-1

In step 203, the UE (100) chooses the PLMN-1 based on slice aware SoR information and S-NSSAI requirement of the UE (100). The UE (100) selects the PLMN-1. In step 204, the UE (100) sends the NAS message e.g., registration request to the PLMN-1. The UE (100) includes S-NSSAI-1 and S-NSSAI-2 as requested NSSAI in the registration request message. In step 205, the UE (100) receives the NAS message e.g. registration accept which includes S-NSSAI-1 and S-NSSAI-2 in allowed NSSAI list. In step 206, the UE (100) goes to an idle mode. In step 207, the higher priority PLMN search timer (also called as timer T as specified in TS 23.122) has elapsed/expired. In step 208, the UE (100) performs the higher priority PLMN search as per the OPLMN list priority and finds the PLMN-2 as higher priority PLMN compared to PLMN-1 as per HPLMN (200)/EHPLMN/UPLMN/OPLMN list stored in the UE (100). In step 209, the UE (100) registers over the PLMN-2. The UE (100) loses service of S-NSSAI-2.

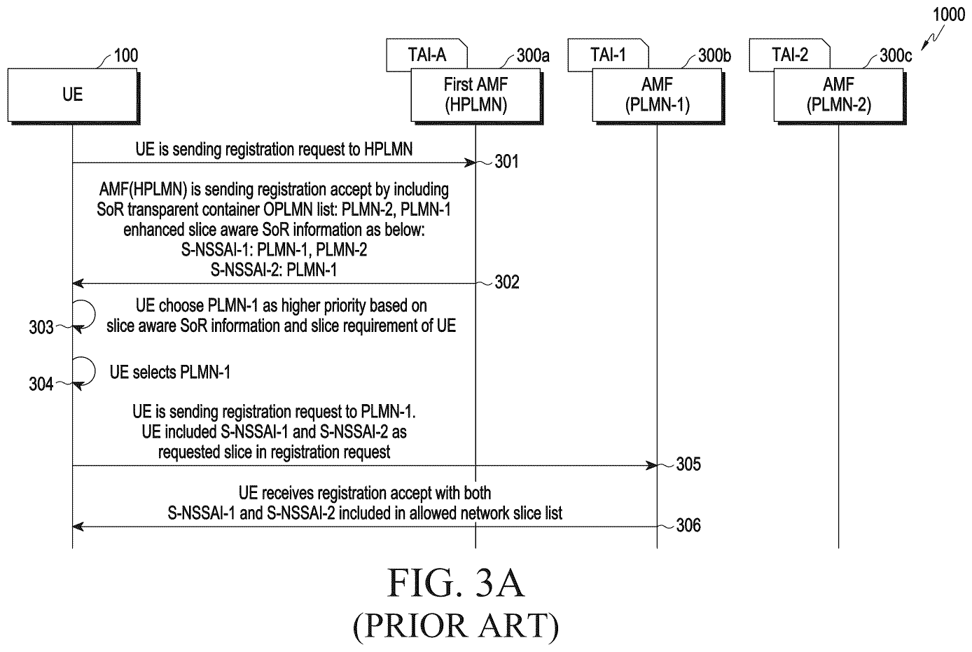

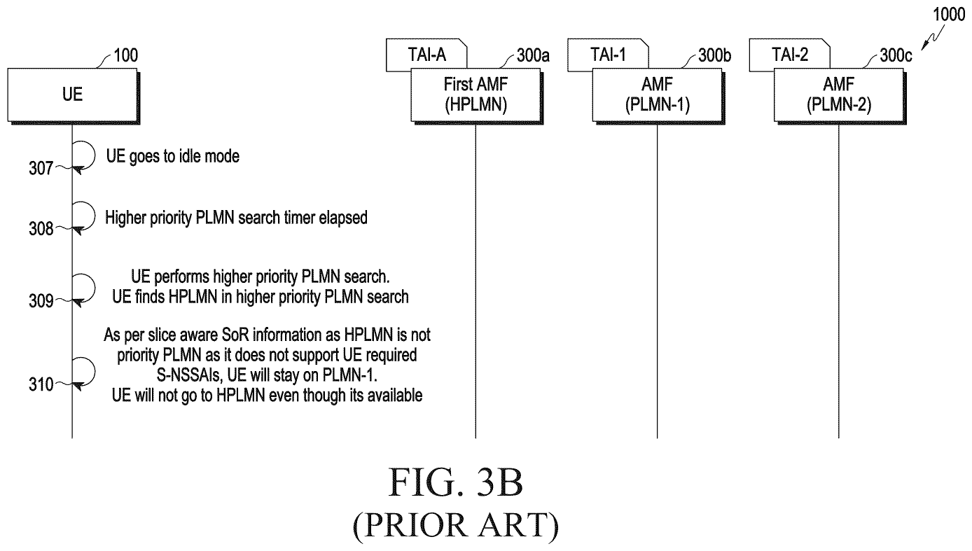

FIGS. 3A and 3B illustrate an example scenario, wherein the home PLMN may not be considered as the higher priority based on the slice aware information. In step 301, the UE (100) is sending any UL NAS message e.g. registration request to the PLMN-A. In step 302, the AMF (PLMN-A) (300a) is sending any DL NAS message e.g. registration accept by including the SoR transparent container OPLMN list: PLMN-2, PLMN-1 and Enhanced Slice Aware SoR information as below:
a) S-NSSAI-1: PLMN-1, PLMN-2, and
b) S-NSSAI-2: PLMN-1.

In step 303, the UE (100) chooses the PLMN-1 as higher priority based on enhanced slice aware SoR information and S-NSSAI requirement of the UE (100). In step 304, the UE (100) selects the PLMN-1. In step 305, the UE (100) is sending any UL NAS message e.g., registration request to PLMN-1. The UE (100) included S-NSSAI-1 and S-NSSAI-2 as requested NSSAI in the registration request. In step 306, the UE (100) receives any DL NAS message e.g., registration accept with cause #62 and indicates S-NSSAI-1 “S-NSSAI not available in the current registration area” and puts S-NSSAI-2 in allowed NSSAI list. In step 307, the UE (100) goes to the idle mode. In step 308, the higher priority PLMN search timer T has elapsed. In step 309, the UE (100) performs a higher priority PLMN search, and the UE (100) finds the HPLMN (200) in the higher priority PLMN search. In step 310, the as per Slice aware SoR information as the HPLMN (200) is not the priority PLMN as it does not support UE required S-NSSAIs, the UE (100) stay on PLMN-1. The UE (100) will not go to the HPLMN (200) even though its available.

Further, the following principles are concluded for key issue (KI) #2 (as in TR 23.700-41, 8.2), a slice based SoR mechanism to deliver enhanced slice-aware SoR information reuses a current SoR mechanism defined in technical specification (TS) 23.122 for SoR information delivery.

Only the UE supporting slice based SoR feature can receive the enhanced slice-aware SoR information via a UDM entity (400), the enhanced slice aware information includes preferred PLMNs for specific S-NSSAIs in the UE subscription (a preferred PLMN list may be also be a single PLMN that is known by the HPLMN (200) to support the S-NSSAI, or a list of PLMNs in preference order that differs from the order of the basic SoR information that is also provided). When more than one S-NSSAI has slice aware information and all these S-NSSAIs are needed by the UE (100), a weighted approach to preferred PLMN selection is proposed.

If the MS is in a VPLMN and not registered for disaster roaming services, the MS periodically attempts to obtain service on its HPLMN (200) (if the EHPLMN list is not present or is empty) or one of its EHPLMNs (if the EHPLMN list is present) or the higher priority PLMN/access technology combinations listed in “user controlled PLMN selector” or “operator controlled PLMN selector” by scanning in accordance with the requirements that are applicable to (i), (ii) and (iii) as defined in the Automatic Network Selection Mode in clause 4.4.3.1.1. For this purpose, a value of timer T may be stored in a Subscriber Identity Module (SIM). The interpretation of the stored value depends on the radio capabilities supported by the MS:
For an MS that does not support any of the following: EC-GSM-IoT, Category M1 or Category Narrow band (NB1) (as defined in 3GPP TS 36.306);
1. if the MS is in a VPLMN through satellite NG-RAN access or satellite E-UTRAN access with a shared MCC, T is in the range 6 multiplied by integer M minutes to 8 multiplied by integer M hours in 6 multiplied by integer M minutes steps or T indicates that no periodic attempts shall be made. If no value for M is stored in the SIM, a default value of M equal to one is used; or
2. otherwise, T is either in the range 6 minutes to 8 hours in 6 minutes steps or it indicates that no periodic attempts shall be made. If no value for T is stored in the SIM, a default value of 60 minutes is used for T.

For the MS that only supports any of the following or a combination of: EC-GSM-IoT, Category M1 or Category NB1 (as defined in 3GPP TS 36.306), T is either in the range 2 hours to 240 hours, using 2 hour steps from 2 hours to 80 hours and 4 hour steps from 84 hours to 240 hours, or it indicates that no periodic attempts shall be made. If no value for T is stored in the SIM, a default value of 72 hours is used.

For an MS that supports both:
1. any of the following or a combination of: EC-GSM-IoT, Category M1 or Category NB1 (as defined in 3GPP TS 36.306); and
2. any access technology other than the following: EC-GSM-IoT, Category M1 or Category NB1 (as defined in 3GPP TS 36.306), below:
T is interpreted depending on the access technology in use as specified
a) if the MS is using any of the following at the time of starting timer T: EC-GSM-IoT, Category M1 or Category NB1 (as defined in 3GPP TS 36.306), T is either in the range 2 hours to 240 hours, using 2 hour steps from 2 hours to 80 hours and 4 hour steps from 84 hours to 240 hours, or it indicates that no periodic attempts shall be made. If no value for T is stored in the SIM, a default value of 72 hours is used; and
b) if the MS is not using any of the following at the time of starting timer T: EC-GSM-IoT, Category M1 or Category NB1 (as defined in 3GPP TS 36.306), T is either in the range 6 minutes to 8 hours in 6 minutes steps or it indicates that no periodic attempts shall be made. If the MS is using the satellite NG-RAN access technology or the satellite E-UTRAN access technology with a shared MCC at the time of starting timer T: T is in the range 6 multiplied by integer M minutes to 8 multiplied by integer M hours in 6 multiplied by integer M minutes steps. If no value for M is stored in the SIM, a default value of M equal to one is used. If no value for T is stored in the SIM, a default value of 60 minutes is used for T.

If the MS is configured with the MinimumPeriodicSearchTimer as specified in 3GPP TS 24.368 or 3GPP TS 31.102, the MS shall not use a value for T that is less than the MinimumPeriodicSearchTimer. If the value stored in the SIM, or the default value for T (when no value is stored in the SIM), is less than the MinimumPeriodicSearchTimer, then T shall be set to the MinimumPeriodicSearchTimer.

The MS does not stop timer T, as described in 3GPP TS 24.008 and 3GPP TS 24.301, when it activates power saving mode (PSM) (see 3GPP TS 23.682) or mobile initiated connection only mode (MICO) as described in 3GPP TS 24.501.

The MS does not stop timer T, as described in 3GPP TS 24.008 and 3GPP TS 24.301, when the access stratum is de-activated due to discontinuous coverage (see 3GPP TS 23.401 and 3GPP TS 24.301).

The MS can be configured for fast first higher priority PLMN search as specified in 3GPP TS 31.102 or 3GPP TS 24.368. The fast first higher priority PLMN search is enabled if the corresponding configuration parameter is present and set to enabled. Otherwise, the fast first higher priority PLMN search is disabled

The attempts to access the HPLMN (200) or an EHPLMN or higher priority PLMN shall be as specified below:
a) The periodic attempts shall only be performed in an automatic mode when the MS is roaming, and not while the MS is attached for emergency bearer services, is registered for emergency services, has a Packet Data Unit (PDU) session for emergency services or has a Packet Data Network (PDN) connection for emergency bearer services;
b) The MS shall make the first attempt after a period of at least 2 minutes and at most the time configured for T:
   only after switch on if the fast first higher priority PLMN search is disabled; or
   after switch on or upon selecting a VPLMN if Fast First Higher Priority PLMN search is enabled.
c) The MS shall make the following attempts if the MS is on the VPLMN at time T after the last attempt;
d) Periodic attempts shall only be performed by the MS while in idle mode or 5GMM-CONNECTED mode with RRC inactive indication (see 3GPP TS 24.501);
   d1) Periodic attempts may be postponed while the MS is in power saving mode (PSM) (see 3GPP TS 23.682) or when the access stratum is deactivated due to discontinuous coverage (see 3GPP TS 23.401 and 3GPP TS 24.301).
   d2) Periodic attempts may be postponed while the MS is receiving eMBMS transport service in idle mode (see 3GPP TS 23.246).
   d3) Periodic attempts may be postponed while the MS is receiving broadcast MBS service in idle mode (see 3GPP TS 23.247).
   d4) Periodic attempts may be postponed till the next eDRX occasion while the MS is configured with eDRX.
   d5) Periodic attempts may be postponed while the MS is in relaxed monitoring (see 3GPP TS 36.304).
   d6) Periodic attempts may be postponed while the MS is in Mobile Initiated Connection Only mode (MICO).
e) If the HPLMN (200) (if the EHPLMN list is not present or is empty) or a EHPLMN (if the list is present) or a higher priority PLMN is not found, the MS remains on the VPLMN.
f) In steps i), ii) and iii) of clause 4.4.3.1.1 the MS shall limit its attempts to access higher priority PLMN/access technology combinations to PLMN/access technology combinations of the same country as the current serving VPLMN, as defined in Annex B

EXCEPTION: If the MS is in a VPLMN through satellite NG-RAN access or satellite E-UTRAN access with a shared MCC, the MS may attempt to access higher priority PLMN/access technology combinations irrespective of their MCC values.

EXCEPTION: If the MS is in a VPLMN, the MS may attempt to access higher priority PLMNs with a shared MCC with satellite NG-RAN access technology or satellite E-UTRAN access technology irrespective of their MCC values.
f1) In the case that the MS has a stored “Equivalent PLMNs” list the MS shall only select a PLMN if it is of a higher priority than those of the same country as the current serving PLMN which are stored in the “Equivalent PLMNs” list.

EXCEPTION: If the MS is in a VPLMN through satellite NG-RAN access or satellite E-UTRAN access with a shared MCC, the MS shall only select a PLMN if it is of a higher priority than those which are stored in the “Equivalent PLMNs” list

EXCEPTION: If the MS is in a VPLMN, the MS shall only select a PLMN if it is of a higher priority than those of the same country as the current serving PLMN or those with a shared MCC with satellite NG-RAN access technology or satellite E-UTRAN access technology which are stored in the “Equivalent PLMNs” list.
g) Only the priority levels of Equivalent PLMNs of the same country as the current serving VPLMN, as defined in Annex B, and which are not in the list of “PLMNs where registration was aborted due to SOR” if the UE (100) has a list of “PLMNs where registration was aborted due to SOR” shall be taken into account to compare with the priority level of a selected PLMN.
h) If the PLMN of the highest priority PLMN/access technology combination available is the current VPLMN, or one of the PLMNs in the “Equivalent PLMNs” list and is not in the list of “PLMNs where registration was aborted due to SOR” if the UE (100) has a list of “PLMNs where registration was aborted due to SOR”, the MS shall remain on the current PLMN/access technology combination.

In step iii) of clause 4.4.3.1.1 the MS shall consider PLMNs which are in the list of “PLMNs where registration was aborted due to SOR” as lowest priority, if the UE (100) has a list of “PLMNs where registration was aborted due to SOR”.

Please note that, as an MS implementation option, the MS can make an attempt when the timer TD, TE, TF, TG or TH expires and there is a PLMN/access technology combination which the MS could not select while the timer was running (e.g. the PLMN was in the list of PLMNs where voice service was not possible in E-UTRAN) that is higher priority than the current serving PLMN and belongs to the same country as the current serving PLMN, as defined in Annex B.

Please note that, as an MS implementation option, upon a transition in or out of international areas, a UE (100) supporting satellite NG-RAN or satellite E-UTRAN can attempt to obtain service on a higher priority PLMN as defined in this clause. It is up to the UE (100) implementation to determine when it is transitioning in and out of international areas. What constitutes an international area is out of scope of this specification and not the responsibility of 3GPP.

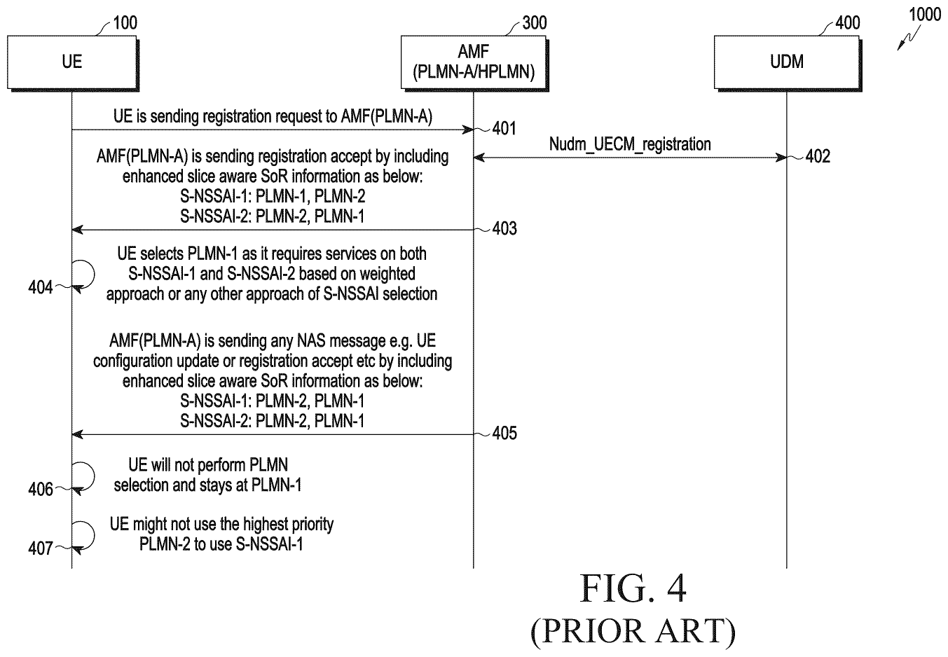

FIG. 4 illustrates a scenario, wherein the slice aware SoR information does not trigger the PLMN search. In step 401, the UE (100) is sending the NAS message e.g. registration request to the AMF (300) or any other Network Function (NF). In step 402, the AMF (300) interacts with the UDM (or UDM entity) (400) and perform NUDM_UECM_Registration. In step 403, the any NF e.g. AMF (PLMN-A) (300a) is sending the NAS message e.g. registration accept by including enhanced Slice Aware SoR information as below:
a) S-NSSAI-1: PLMN-1, PLMN-2, and
b) S-NSSAI-2: PLMN-2, PLMN-1

In step 404, the UE (100) selects a PLMN-1 as it requires services on both S-NSSAI-1 and S-NSSAI-2 based on weighted approach or any other approach of S-NSSAI selection. In step 405, NF e.g. AMF (PLMN-A) (300a) is sending any NAS message e.g. UE configuration update or Registration accept etc by including enhanced Slice Aware SoR information as below:
a) S-NSSAI-1: PLMN-2, PLMN-1, and
b) S-NSSAI-2: PLMN-2, PLMN-1

In step 406, the UE (100) does not perform PLMN selection and stays at the PLMN-1. In step 407, the UE (100) might not use the highest priority PLMN-2 to use S-NSSAI-1.

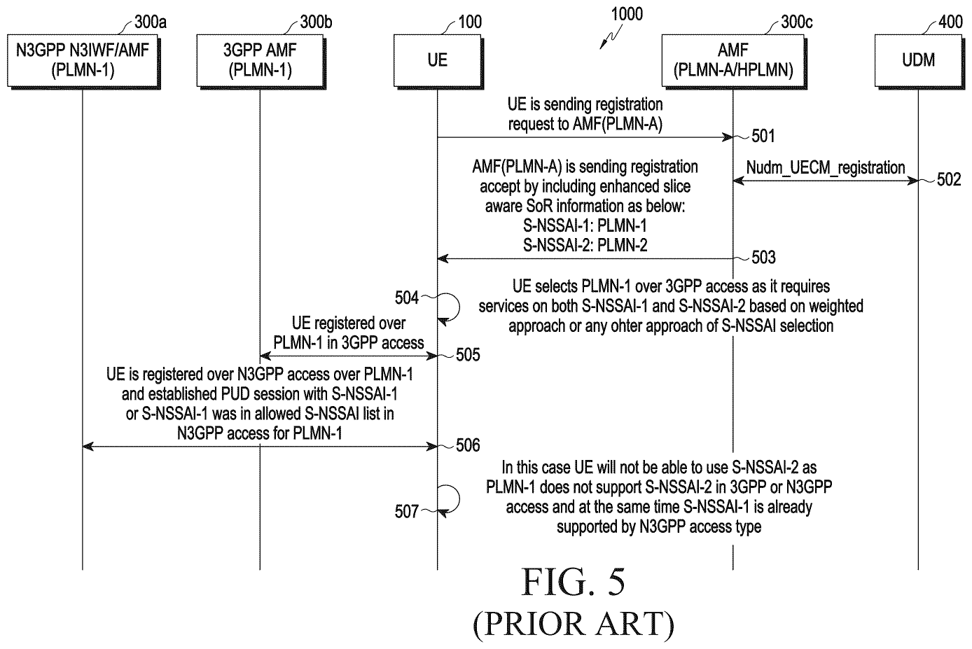

FIG. 5 illustrates a scenario, wherein the PLMN search does not consider availability of other access types. In step 501, the UE (100) is sending the NAS message e.g. registration request to any Network Function Entity e.g. AMF (PLMN-A) (300a). In step 502, the Network Function Entity (NF) e.g. AMF (300) interacts with the UDM (400) and perform NUDM_UECM_Registration. In step 503, the Network Function Entity e.g. AMF (PLMN-A) (300a) is sending NAS message e.g. Registration Accept by including enhanced Slice Aware SoR information as below:
a) S-NSSAI-1: PLMN-1, and
b) S-NSSAI-2: PLMN-2

In step 504, the UE (100) selects PLMN-1 over 3GPP access as it requires services on both S-NSSAI-1 and S-NSSAI-2 based on weighted approach or any other approach of S-NSSAI selection. In step 505, the UE (100) registered over the PLMN-1 in the 3GPP access. In step 506, the UE (100) is registered over the N3GPP access over the PLMN-1 and established PDU session with S-NSSAI-1 or S-NSSAI-1 was in the allowed S-NSSAI list in N3GPP access for PLMN-1. In step 507, in this case, the UE (100) will not be able to use S-NSSAI-2 as PLMN-1 does not support S-NSSAI-2 in 3GPP or N3GPP access and at the same time S-NSSAI-1 is already supported by N3GPP access type.

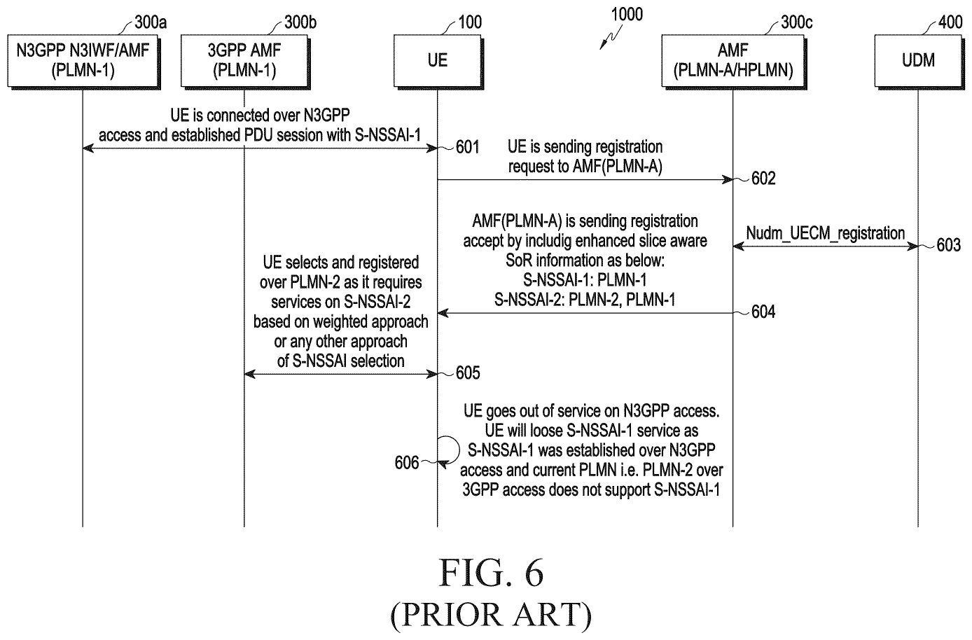

FIG. 6 illustrates a scenario, wherein the PLMN search does not consider other access types goes to 5GMM DEREGISTERED NO-CELL-AVAILABLE or 5GMM-REGSITERED.NO-CELL AVAILABLE state. In step 601, the UE (100) is connected over a N3GPP access and established PDU session with S-NSSAI-1. In step 602, the UE (100) is sending the NAS message e.g. registration request to the AMF (PLMN-A) (300a). In step 603, the AMF (300) interacts with the UDM (400) and performs NUDM_UECM_Registration. In step 604, the NF (e.g. AMF (PLMN-A)) (300a) is sending the NAS message e.g. registration accept by including enhanced Slice Aware SoR information as below:
S-NSSAI-1: PLMN-1, and
S-NSSAI-2: PLMN-2

In step 605, the UE (100) selects and registered over the PLMN-2 as it requires services on S-NSSAI-2 based on weighted approach or any other approach of S-NSSAI selection. In step 606, the UE (100) goes 5GMM DEREGISTERED NO-CELL-AVAILABLE or 5GMM-REGSITERED.NO-CELL AVAILABLE state on N3GPP access. The UE (100) loses S-NSSAI-1 service as S-NSSAI-1 was established over N3GPP access and current PLMN i.e. PLMN-2 over 3GPP access does not support S-NSSAI-1.

The embodiments herein achieve method for handling a PLMN selection in a wireless network. The method includes receiving, by a UE, a slice aware SoR information from a network entity. Further, the method includes determining, by the UE, a required network slice. Further, the method includes selecting, by the UE, a PLMN from a plurality of PLMNs based on a priority order defined for each PLMN from the plurality of PLMNs with respect to the determined required network slice. Further, the method includes triggering, by the UE, a registration procedure with the selected PLMN by sending a registration request message to the network entity.

The following abbreviations and definitions have been referred to herein:
a) SoR-CMCI: Steering of roaming connected mode control information,
b) SoR: Steering of Roaming,
c) SR: Service Request,
d) TAI: Tracking Area Identity,
e) TAC: Tracking Area Code,
f) CAG: Closed Access Group,
g) 3GPP: 3^{rd} Generation Partnership Project,
h) AMF: Access and Mobility Function,
i) GCI: Global Cell Id,
j) NSSAI: Network Slice Selection Assistance Information,
k) CAG: Closed Access Group,
l) OPLMN: Operator Preferred PLMN, and
m) PLMN: Public Land Mobile Network
n) UPLMN: user controlled PLMN selector

The term 5GMM sublayer states in this embodiment are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED

In this embodiment the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

Embodiments herein illustrate the network functions using the AMF, UDM as example, but embodiments herein are not limited to illustrated network functions and these can be any other existing or a new network function executing the described behavior as disclosed herein.

The method can be used for performing assisted PLMN selection, where the network can provide more granularity as a part of enhanced slice aware SoR information. The method can be used for performing assisted PLMN selection, where the UE considers HPLMN search if all required slices are supported in other PLMNs. The method can be used for performing assisted PLMN selection, wherein the Home PLMN will always be considered as Higher priority PLMN irrespective of slice support.

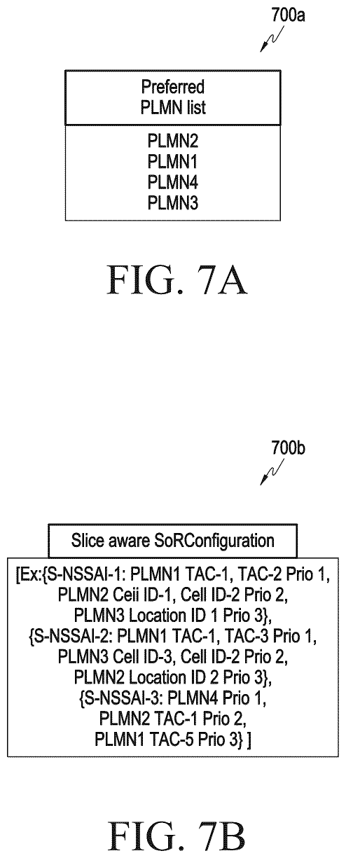

Referring now to the drawings, and more particularly to FIGS. 7A through 16, where similar reference characters denote corresponding features consistently throughout the figures, there are shown at least one embodiment.

Embodiments herein can enable the network to provide more granularity as a part of enhanced slice aware SoR information.
a) Proposal of Enhanced slice aware SOR information: OPLMN list. PLMN-1, PLMN-2, PLMN-3, PLMN-4, and PLMN-5,
b) SNSSAI-1 Supported area: PLMN-1 (TAI-1, TAI-2, and TAI-3), PLMN-2 (Global Cell Id-1, Global Cell id-2, Global Cell Id-3, TAI-1, and TAI-2), PLMN-3 (Geographical Location-x), PLMN-4 (CAG-1, TAI-1, Global cell ID-2),
c) SNSSAI-2 Supported area: PLMN-1 (TAI-3, TAI-4), PLMN-2 (Global Cell id-2, and Global Cell id-3), PLMN-3, and PLMN-4, and
d) SNSSAI-3 Supported area: PLMN-5.

As disclosed herein in the proposed method, the network may include tracking area level or Global cell id level or location level information while providing enhanced slice aware SoR information. The tracking area or cell or location level granularity will help the UE (100) to not only select the PLMN, but also to select correct tracking area or cell id available in that area. If only PLMN information is provided in the slice aware SoR information, the UE (100) may assume that particular slice is supported by entire PLMN homogeneously or there can be dedicated indication that the PLMN supports that S-NSSAI homogenously across the PLMN area.

As per above example, the SNSSAI-1 is supported by the PLMN-1 in Tracking Area Id 1, 2 and 3. The SNSSAI-1 is also supported by PLMN-2 and GCI 1, 2 and 3 and TAI-1, TAI-2. The SNSSAI-1 is also supported by the PLMN-3 having geographical location (identified by one or more of the following TAC, GCI, co-ordinates or Latitude/Longitude etc.)

Similarly, the SNSSAI-2 is supported by the PLMN-1 in TAI 3 and 4. The S-NSSAI-2 is also supported by the PLMN-2 having GCI 2 and 3. The SNSSAI-2 is supported by the PLMN-3 and PLMN-4 homogeneously. The SNSSAI-3 is supported by the entire PLMN-5 homogeneously. An explicit indication can be provided to the UE (100) that S-NSSAI is supported in all the area homogeneously across the PLMN.

FIGS. 7A and 7B depict example scenarios, wherein the network is provided with more granularity as a part of slice aware SoR information, according to the embodiments as disclosed herein. Embodiments herein provide additional granularity information (e.g. tracking area code or tracking area id, global cell id, Location id etc.,) while providing the Slice aware SoR information to help UE (100) perform PLMN selection accordingly. On the PLMN id being provided as a part of slice aware SoR information, then the UE (100) considers the particular S-NSSAI as being supported in the entire PLMN.

The UE (100) searches relevant Tracking Area Ids, or Cell ids or CAG based on information provided in Slice aware SoR Information to select a PLMN/TAI/cell which supports the required S-NSSAI(s). In other words, the UE (100) searches for relevant tracking area or Cell ids or CAGs which are provided in slice aware information as a part of PLMN search and select the appropriate PLMN/cell/TAI based on what is most required S-NSSAI(s) to the UE (optionally in priority order). As an example, if slice aware information contains below:
{S-NSSAI-1: PLMN1 TAC-1, TAC-2 Prio 1,
PLMN2 Cell id-1, Cell id-2 Prio 2,
PLMN3 Location id 1 Prio 3},
{S-NSSAI-2: PLMN1 TAC-1, TAC-3 Prio 1,
PLMN3 Cell id-3, Cell id-2 Prio 2,
PLMN2 Location id 2 Prio 3},

If the S-NSSAI-1 is needed by the UE (100), the UE (100) prioritizes and selects as follows: the TAC-1 of the PLMN1 is priority 1, TAC-2 of the PLMN1 is priority 2, Cell Id-1 of the PLMN2 is priority 3, Cell id-2 of the PLMN2 is priority 4 and so on.

If the S-NSSAI-2 is needed by the UE (100), the UE (100) prioritizes and selects as follows: TAC-1 of the PLMN1 is priority 1, TAC-3 of the PLMN1 is priority 2, Cell Id-3 of the PLMN3 is priority 3, Cell id-2 of PLMN3 is priority 4 and so on.

Model 1: The UE (100) can be configured in the below priority order and the MS (Mobile Station)/UE (User Equipment) selects and attempts registration on other PLMN/access technology combinations, if available and allowable (optionally) in below priority order for:
a) HPLMN (200)/EHPLMN.
b) UPLMN list: each PLMN/access technology combination in the “User Controlled PLMN Selector with Access Technology” data file in the SIM (in priority order).

OPLMN list-or-enhanced Slice aware SOR information list.

Random PLMNs.

OPLMN list: each PLMN/access technology combination in the “Operator Controlled PLMN Selector with Access Technology” data file in the SIM (in priority order) or stored in the ME (in priority order).

If the UE (100) intends to use the S-NSSAI optionally not supported by the current registered PLMN, then the UE (100) should use the slice aware SOR information configured in the UE (100) and optionally ignore the OPLMN list. Otherwise, the UE (100) ignores enhanced Slice aware SOR information list and use OPLMN list.

In yet another embodiment, the UE (100) shall prioritize to use the OPLMN list, but if the UE (100) intends to use the S-NSSAI optionally not supported by current registered PLMN, then the UE (100) should use the slice aware SOR information configured in the UE (100) and ignore the OPLMN list.

Model 2: The UE (100) can be configured in the below priority order and the MS/UE selects and attempts registration on other PLMN/access technology combinations, if available and allowable (optionally) in below priority order:
a) HPLMN (200)/EHPLMN.
b) UPLMN list: each PLMN/access technology combination in the “User Controlled PLMN Selector with Access Technology” data file in the SIM (in priority order).
c) OPLMN list.
d) enhanced Slice aware SOR information list.
c) Random PLMNs.

OPLMN list: each PLMN/access technology combination in the “Operator Controlled PLMN Selector with Access Technology” data file in the SIM (in priority order) or stored in the ME (in priority order).

If the UE (100) intends to use the S-NSSAI optionally not supported by the current registered PLMN, then the UE (100) should use the slice aware SOR information configured in the UE (100) and ignore the OPLMN list.

In yet another embodiment, the UE (100) shall prioritize to use the OPLMN list, but if the UE (100) intends to use a S-NSSAI optionally not supported by the current registered PLMN, then the UE (100) should use the slice aware SOR information configured in the UE (100) and ignore the OPLMN list.

Model 3: The UE (100) can be configured in the below priority order and The MS/UE selects and attempts registration on other PLMN/access technology combinations, if available and allowable (optionally) in below priority order:
a) HPLMN (200)/EHPLMN.
b) UPLMN list: each PLMN/access technology combination in the “User Controlled PLMN Selector with Access Technology” data file in the SIM (in priority order).
c) enhanced Slice aware SOR information list.
d) OPLMN list.
e) Random PLMNs.

The OPLMN list: each PLMN/access technology combination in the “Operator Controlled PLMN Selector with Access Technology” data file in the SIM (in priority order) or stored in the ME (in priority order).

The UE (100) supporting enhanced Slice aware SOR information list feature prioritizes to use the configured priority of PLMNs in the enhanced Slice aware SOR information list (can be configured in ME or USIM of the UE) if the UE (100) is not able to find the appropriate PLMN, then the UE (100) selects the PLMN from the OPLMN list. That is, the priority of the OPLMN list is lower than the priority of the PLMNs in enhanced Slice aware SOR information list.

In this embodiment, if the UE (100) selects the PLMN refers to all modes of selection i.e. Automatic Network Selection Mode and Manual Network Selection Mode. The priority discussed for Model-1, Model-2 or Model-3 is also applied during higher priority PLMN search/selection, i.e., after timer T expiry.

Model 4: The UE (100) can be configured in the below priority order and the MS/UE selects and attempts registration on other PLMN/access technology combinations, if available and allowable (optionally) in below priority order:
a) HPLMN (200)/EHPLMN.
b) UPLMN list: each PLMN/access technology combination in the “User Controlled PLMN Selector with Access Technology” data file in the SIM (in priority order).
c) OPLMN list (including-enhanced Slice aware SOR information list).
d) Random PLMNs.

OPLMN list: each PLMN/access technology combination in the “Operator Controlled PLMN Selector with Access Technology” data file in the SIM (in priority order) or stored in the ME (in priority order). Each PLMN is having supported S-NSSAI(s) information. Based on the UEs preference, if a given PLMN is not supporting UEs preferred/required S-NSSAI, then the UE (100) ignores or deprioritizes the entry of the PLMN in the OPLMN list.

The random PLMNs can be other PLMN/access technology combinations with received high quality signal in random order or other PLMN/access technology combinations in order of decreasing signal quality. Note that high quality signal is defined in the appropriate AS specification.

In yet another embodiment, there can be a dedicated indication that the PLMN supports all the subscribed S-NSSAI(s) i.e., NSSAIs of the UE (100) in enhanced Slice aware SOR information. That is, this PLMN can act as wild card for any S-NSSAI.

Optional coding technique for Slice aware SoR list:

Optionally, the network can provide slice aware SoR list as below with similar granularity.
a) PLMN 1-S-NSSAI 1 (TAI-1/Cell id-1/CAG id-1/Location-1), S-NSSAI-2 (TAI-2/Cell id-2/CAG id-2/Location-2), and
b) PLMN 2-S-NSSAI 1 (TAI-3/Cell id-3/CAG id-3/Location-3), S-NSSAI-4 (TAI-3/Cell id-3/CAG id-3/Location-3).

As per above list, the network can provide the slice aware SoR list having each PLMN id and slice list with granularity for each slice support. For instance, as per above example, PLMN-1 supports S-NSSAI-1 in TAI-1 or Cell id-1 or CAG id-1 or Location-1 and PLMN-1 supports S-NSSAI-2 in TAI-2 or Cell id-2 or CAG id-2 or Location-2. Similarly, PLMN-2 supports S-NSSAI-1 in TAI-3, Cell id-3 or CAG-id-3 or Location-3 and PLMN-2 supports S-NNSAI-4 in TAI-3 or Cell id-3 or CAG id-3 or Location-3.

Optionally, the network can indicate priority for each S-NSSAI along with PLMN id. In another embodiment, the UE (100) may identify priority of S-NSSAI per PLMN as per the order network provided the S-NSSAI for each PLMN.

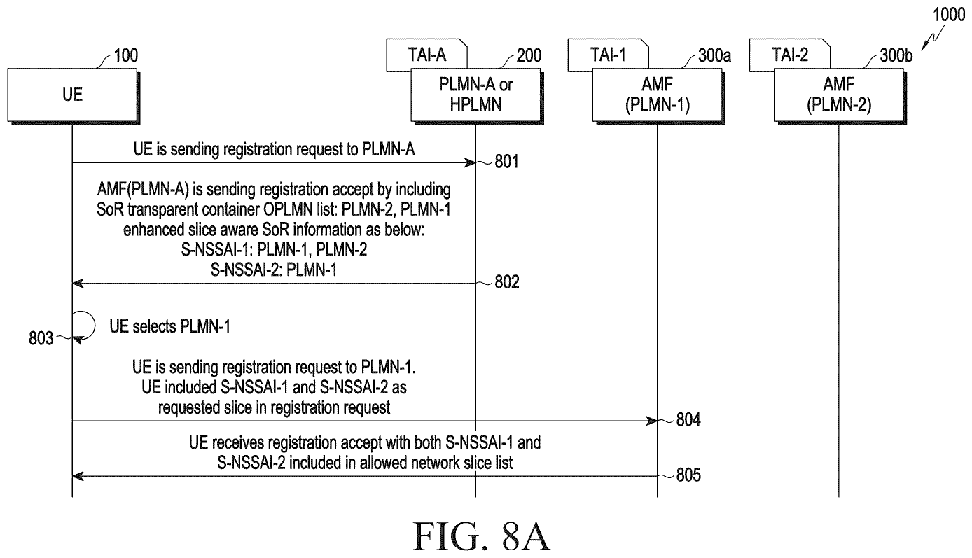

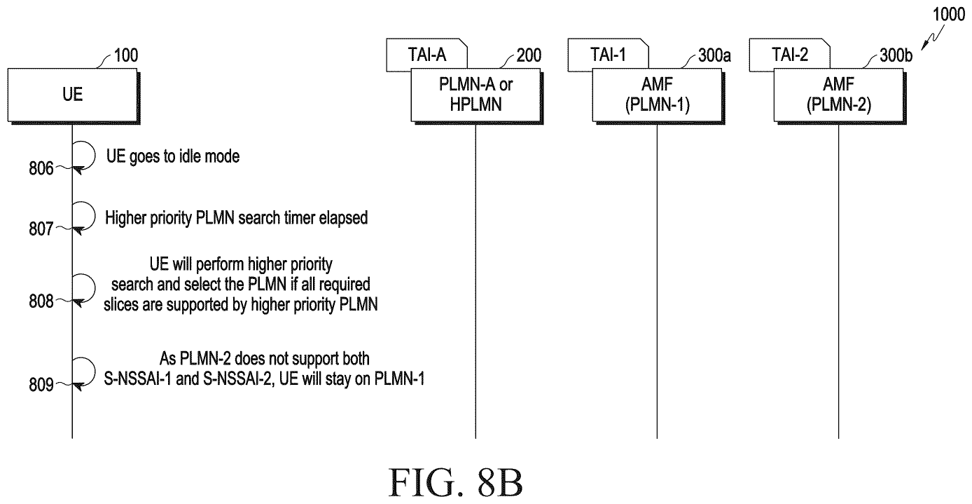

FIGS. 8A and 8B illustrate a scenario, where the UE (100) can consider HPLMN search if all required slices are supported in other PLMN in the wireless network (1000) according to the embodiments as disclosed herein. In step 801, the UE (100) sends the NAS message, e.g., registration request to the PLMN-A. In step 802, the AMF (PLMN-A) sends the NAS message for e.g. registration accept by including the SoR transparent container (any other information element (IE)) OPLMN list: PLMN-2, PLMN-1 and Enhanced Slice Aware SoR information as below:
a) S-NSSAI-1: PLMN-1, PLMN-2; and
b) S-NSSAI-2: PLMN-1.

In step 803, the UE (100) selects the PLMN-1 based on available slice aware SoR information and S-NSSAI requirement of the UE (100). In step 804, the UE (100) sends a NAS message e.g., Registration Request to PLMN-1. The UE (100) includes S-NSSAI-1 and S-NSSAI-2 as requested NSSAI in the registration request. In step 805, the UE (100) receives the NAS message e.g., registration accept which includes S-NSSAI-1 and S-NSSAI-2 in the allowed NSSAI list. In step 806, the UE (100) goes to the idle mode. In step 807, the higher priority PLMN search timer (timer T) has elapsed/expired.

In step 808, the UE (100) performs the higher priority PLMN selection based on granularity (e.g., TAI, Cell id, CAG id, location information etc) provided in slice aware SoR list, if all required S-NSSAIs are supported by the higher priority PLMN. As the PLMN-2 does not support both S-NSSAI-1 and S-NSSAI-2, the UE (100) stays on PLMN-1. i.e. the MS shall periodically attempt to obtain service on available higher priority PLMN which also supports the UE (100) required S-NSSAI(s) (optionally in the same priority order) and optionally, also belongs to the same country. The higher priority PLMN can be a lower priority or a higher priority than the current registered PLMN based on the supported S-NSSAIs.

In step 809, the UE (100) required S-NSSAI(s) can be derived from at least one of the (or part of the) network slicing information stored in the UE (100), Requested NSSAI, Allowed NSSAI list, Configured NSSAI list, default configured NSSAI list, partly allowed NSSAI list, partly Rejected NSSAI list, Rejected NSSAI list or any other list maintained by the UE (100).

In yet another embodiment, if the UE (100) has chosen a PLMN based on Enhanced slice aware SOR information due to the required S-NSSAIs, then the UE (100) shall not trigger higher priority PLMN search i.e. ignore timer T expiry or the UE (100) shall not run (start or restart) the timer T.

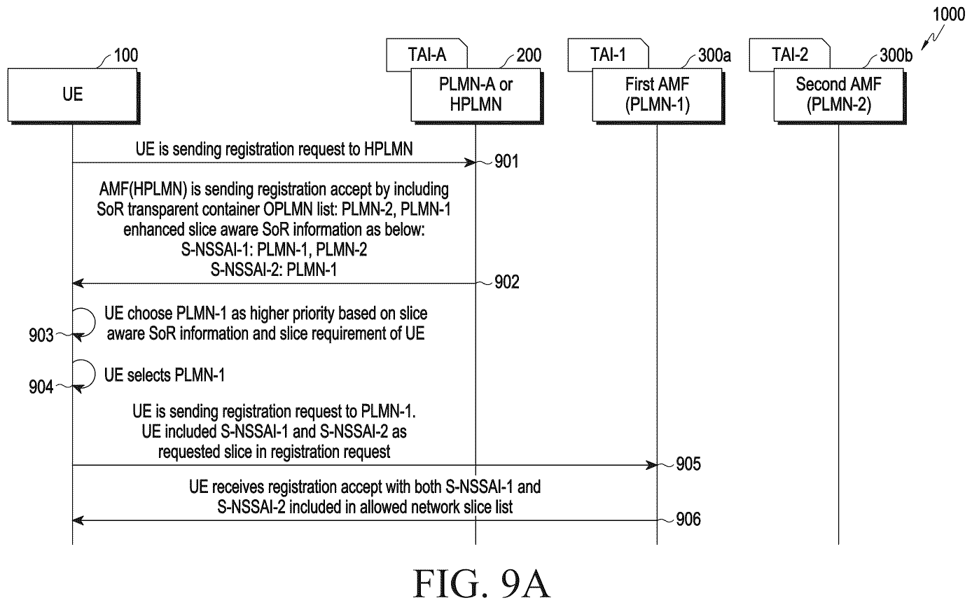

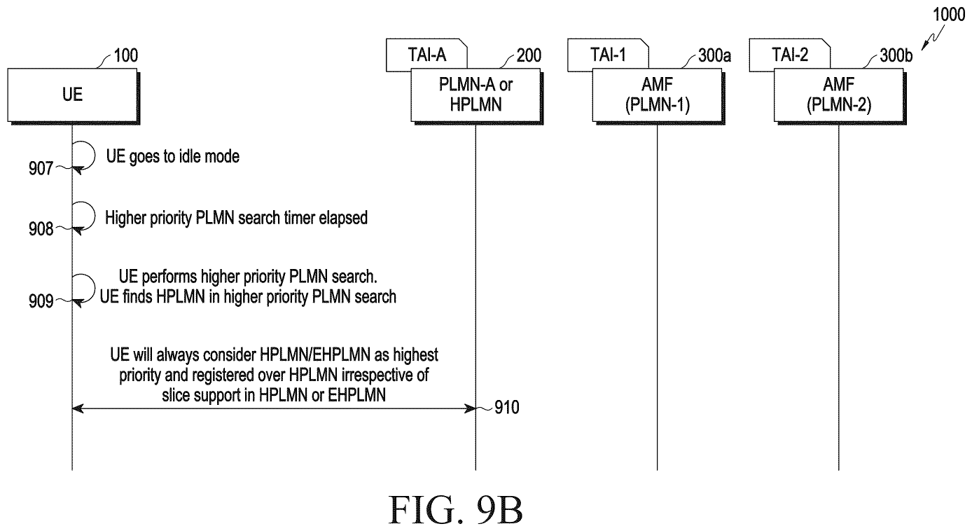

FIGS. 9A and 9B illustrate a scenario, wherein the home PLMN will always be considered as highest priority irrespective of slice support in the wireless network (1000), according to the embodiments as disclosed herein. In step 901, the UE (100) is sending any UL NAS message e.g. registration request to the PLMN-A. In step 902, the AMF (PLMN-A) (300a) is sending the registration accept by including SoR Transparent Container OPLMN list: PLMN-2, PLMN-1 and Enhanced Slice Aware SoR information as below:
a) S-NSSAI-1: PLMN-1, PLMN-2.
b) S-NSSAI-2: PLMN-1.

In step 903, the UE (100) chooses or selects the PLMN-1 as higher priority based on slice aware SoR information and S-NSSAI(s) requirement of the UE (100). In step 904, the UE (100) selects the PLMN-1. In step 905, the UE (100) is sending any UL NAS message e.g. Registration Request to PLMN-1. The UE (100) includes S-NSSAI-1 and S-NSSAI-2 as requested S-NSSAI in the registration request. In step 906, the UE (100) receives any DL NAS message e.g. registration accept with cause #62 and indicates S-NSSAI-1 “S-NSSAI not available in the current registration area” and puts S-NSSAI-2 in the allowed NSSAI list. In step 907, the UE (100) goes to idle mode. In step 908, the higher priority PLMN search timer has elapsed. In step 909, the UE (100) performs the higher priority PLMN search. The UE (100) finds the HPLMN (200)/EHPLMN in higher priority PLMN search. In step 910, the UE (100) always considers the HPLMN (200)/EHPLMN as the highest priority and registers over HPLMN (200)/EHPLMN irrespective of supported S-NSSAI in the HPLMN (200) or EHPLMN.

If the UE (100) is registered with the HPLMN (200)/EHPLMN, then the UE (100) shall ignore the slice aware SoR information. The UE (100) shall not (optionally periodically) attempt to obtain services from other PLMNs, which can provide UE (100) with required S-NSSAI(s). The UE (100) shall use the S-NSSAI supported by the HPLMN (200)/EHPLMN.

The higher priority PLMN search timer T elapsed can signify that the UE (100) shall release the current N1 NAS signaling connection locally and then attempt to obtain service on a higher priority PLMN as specified in clause 4.4.3.3 of TR 23.122 by acting as if timer T that controls periodic attempts has expired.

Enhanced Slice aware SoR (Steering of Roaming) information includes preferred PLMNs for specific S-NSSAIs in the UE subscription. The preferred PLMN list may be a single PLMN that is known by the HPLMN (200) to support the S-NSSAI, or a list of PLMNs in preference order that differs from the order of the basic SoR information that is also provided. Along with the OPLMN list in SoR information, the HPLMN (200) may provide one more list where it maps each slices to a list of PLMNs. The list holds information about which PLMN is considered as a priority PLMN for that particular S-NSSAI. As an example if the list is as follows:
a) S-NSSAI-1: PLMN-1, PLMN-2
b) S-NSSAI-2: PLMN-2, PLMN-1

Consider the above list, the UE (100) considers PLMN-1 as higher priority PLMN compared to PLMN-2 if it wants to use S-NSSAI-1. For S-NSSAI-2, the priority will be reversed. The information assists the UE (100) to choose PLMNs based on service or slice requirement.

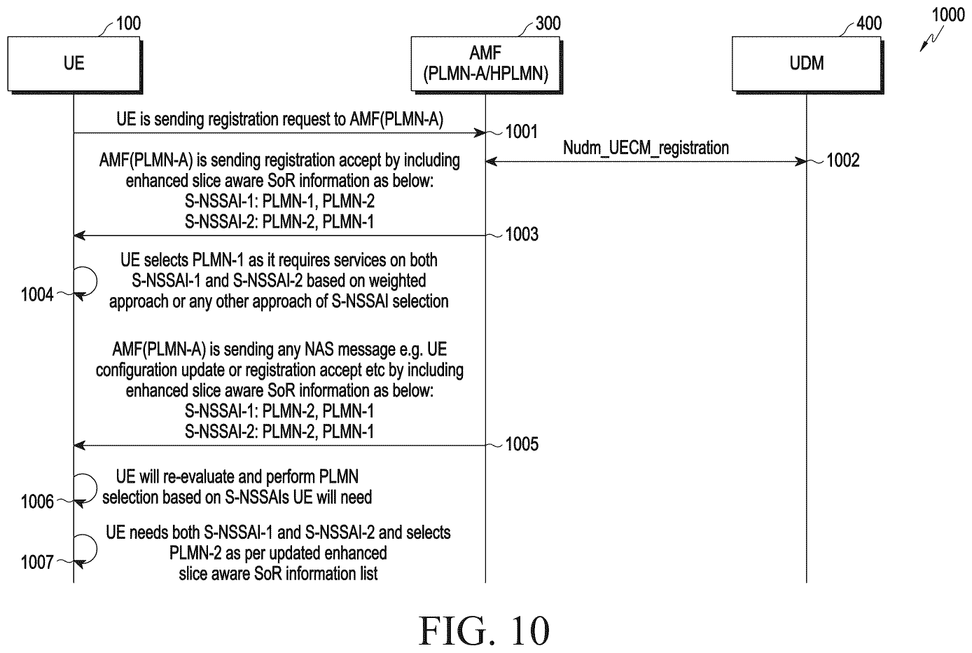

FIG. 10 illustrates a scenario, wherein the slice aware SoR information update may trigger the PLMN search in the wireless network (1000), according to the embodiments as disclosed herein. In step 1001, the UE (100) is sending NAS message e.g., Registration Request to AMF or any other Network Function (NF) Entity. In step 1002, the AMF interacts with the UDM (400) and performs NUDM_UECM_Registration. In step 1003, the AMF (PLMN-A) (300a) is sending NAS message e.g., Registration Accept by including enhanced Slice Aware SoR information as below:
a) S-NSSAI-1: PLMN-1, PLMN-2, and
b) S-NSSAI-2: PLMN-2, PLMN-1

In step 1004, the UE (100) selects PLMN-1 as it requires services on both S-NSSAI-1 and S-NSSAI-2 based on weighted approach or any other approach of S-NSSAI selection. In step 1005, the AMF (PLMN-A) (300a) is sending any NAS message e.g., UE (100) configuration update or Registration accept etc by including enhanced Slice Aware SoR information as below:
a) S-NSSAI-1: PLMN-2, and
b) S-NSSAI-2: PLMN-2

In step 1006, the UE (100) re-evaluates and performs PLMN selection based on S-NSSAIs, that the UE (100) will need. If the UE (100) finds as per weighted approach or any other approach that current PLMN is not suitable to provide service for all required NSSAIs, the UE (100) may release the current N1 NAS signaling connection locally and then attempt to obtain service on a higher priority PLMN as specified in clause 4.4.3.3 of TR 23.122 by acting as if timer T that controls periodic attempts has expired. In step 1007, as per above example, if the UE (100) needs both S-NSSAI-1 and S-NSSAI-2, the UE (100) selects PLMN-2 as PLMN-2 can provide both S-NSSAI-1 and S-NSSAI-2 as per updated enhanced slice aware SoR information list. In step 8, Optionally, the UE (100) may perform PLMN selection once updated slice aware SoR information is being received, after a predefined time (for e.g., Tsor CM timer i.e., based on one or more Tsor-CM timers as configured in SOR_CMCI) or when N1 NAS signaling connection has been released or by performing local NAS signaling connection release.

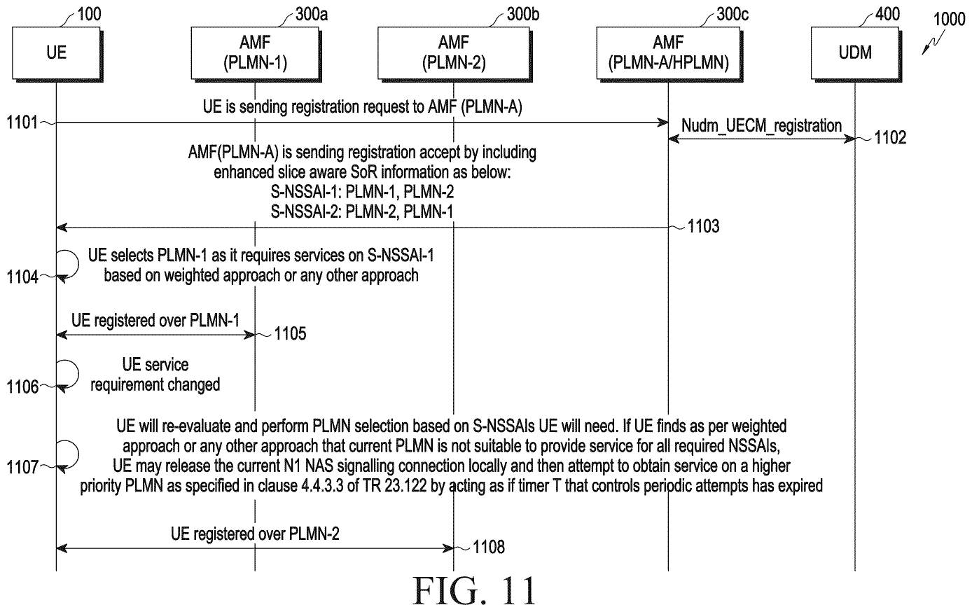

FIG. 11 illustrates a scenario, where the PLMN search is triggered, on detecting a change of S-NSSAI requirement in the wireless network (1000), according to the embodiments as disclosed herein. In step 1101, the UE (100) is sending a NAS message; e.g., Registration Request to the AMF (300a) or any other Network Function (NF). In step 1102, NF e.g. AMF (300a) interacts with the UDM (400) and perform NUDM_UECM_Registration. In step 1103, NF e.g. the AMF (PLMN-A) (300a) is sending NAS message; e.g., Registration Accept by including enhanced Slice Aware SoR information as below:
a) S-NSSAI-1: PLMN-1, PLMN-2, and
b) S-NSSAI-2: PLMN-2, PLMN-1

In step 1104, the UE (100) selects PLMN-1 as it requires services on S-NSSAI-1 based on weighted approach or any other approach. In step 1105, the UE (100) registered over PLMN-1. In step 1106, the UE (100) service requirement changed, and it requires services on S-NSSAI-2. In step 1107, the UE (100) re-evaluates and performs PLMN selection based on S-NSSAIs, that the UE (100) will need. If the UE (100) finds as per weighted approach or any other approach that the current PLMN is not suitable to provide service for all required NSSAIs, the UE (100) may release the current N1 NAS signaling connection locally or wait for all predefined timers; e.g., TSoR-CMCI timer(s) expiry and then attempt to obtain service on a higher priority PLMN as specified in clause 4.4.3.3 of TS 23.122 by acting as if timer T that controls periodic attempts has expired. In step 1108, optionally, the UE (100) may perform PLMN selection based on service requirement change, after a predefined time or when N1 NAS signaling connection has been released or by performing local NAS signaling connection release. In step 1109 (optional, not depicted), in the above example, the UE (100) selects the PLMN-2 as it requires service for S-NSSAI-2.

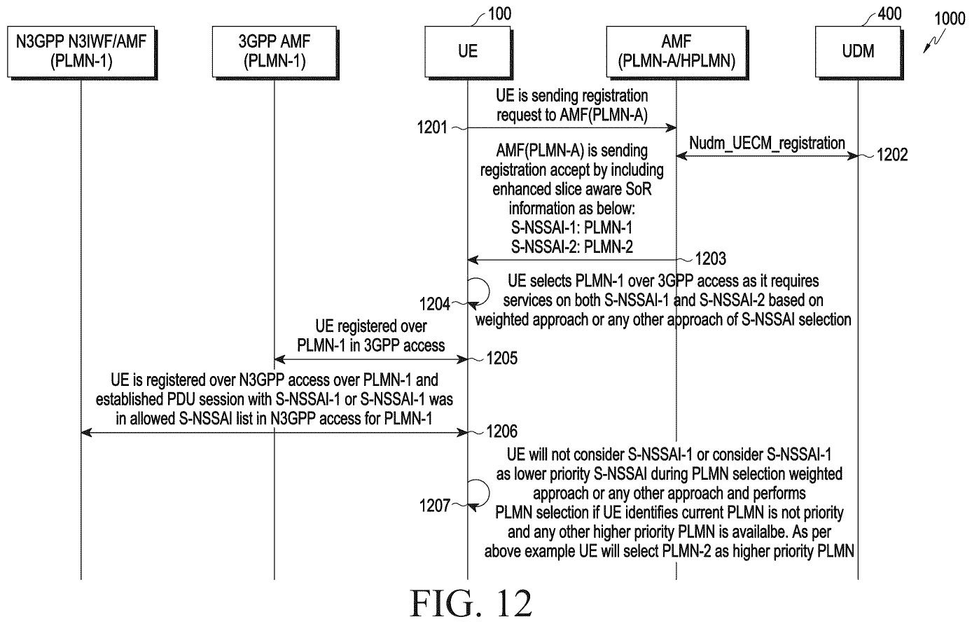

FIG. 12 illustrates a scenario, wherein the availability of other access types is considered during the PLMN search in the wireless network (1000), according to the embodiments as disclosed herein. In step 1201, the UE (100) is sending NAS a message; e.g., Registration Request to any Network Function Entity; e.g., AMF (PLMN-A) (300a). In step 1202, the Network Function Entity; e.g., AMF (300a) interacts with the UDM (400) and perform NUDM_UECM_Registration. In step 1203, the Network Function Entity; e.g., AMF (PLMN-A) is sending NAS message; e.g., Registration Accept by including enhanced Slice Aware SoR information as below:
a) S-NSSAI-1: PLMN-1, and
b) S-NSSAI-2: PLMN-2

In step 1204, the UE (100) selects PLMN-1 over 3GPP access as it requires services on both S-NSSAI-1 and S-NSSAI-2 based on weighted approach or any other approach of S-NSSAI selection. In step 1205, the UE (100) registered over PLMN-1 in 3GPP access. In step 1206, the UE (100) is registered over n3gpp access over PLMN-1 and established PDU session with S-NSSAI-1 or S-NSSAI-1 was in the allowed S-NSSAI list in N3GPP access for PLMN-1. In step 1207, the UE (100) does not consider S-NSSAI-1 or considers S-NSSAI-1 as lower priority S-NSSAI during PLMN selection weighted approach or any other approach and performs PLMN selection if UE (100) identifies current PLMN is not priority and any other higher priority PLMN is available. As per above example UE (100) selects the PLMN-2 as higher priority PLMN.

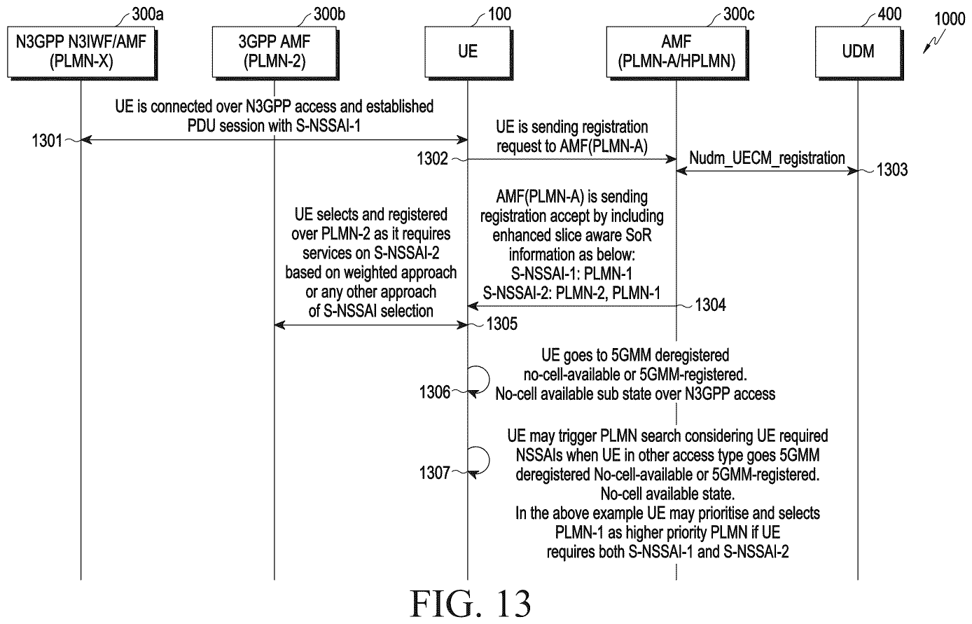

FIG. 13 depict an example scenario, wherein the PLMN search is triggered based on other access type 5GMM DEREGISTERED NO-CELL-AVAILABLE or 5GMM-REGSITERED.NO-CELL AVAILABLE state in the wireless network (1000), according to the embodiments as disclosed herein. In step 1301, the UE (100) is connected over n3gpp access and established PDU session with S-NSSAI-1. In step 1302, the UE (100) is sending NAS message, e.g., Registration Request to the AMF (PLMN-A) (300a) or any other Network Function (NF) Entity. In step 1303, the AMF interacts with the UDM (400) and perform NUDM_UECM_Registration. In step 1304, the NF (e.g. AMF (PLMN-A)) (300a) is sending a NAS message, e.g., Registration Accept by including enhanced Slice Aware SoR information as below:
a) S-NSSAI-1: PLMN-1, and
b) S-NSSAI-2: PLMN-2

In step 1305, the UE (100) selects and registered over PLMN-2 as it requires services on S-NSSAI-2 based on weighted approach or any other approach of S-NSSAI selection. In step 1306, the UE (100) goes to 5GMM DEREGISTERED NO-CELL-AVAILABLE or 5GMM-REGSITERED.NO-CELL AVAILABLE sub state over N3GPP access. In step 1307, the UE (100) may trigger PLMN search considering UE (100) required NSSAIs when UE (100) in other access type goes 5GMM DEREGISTERED NO-CELL-AVAILABLE or 5GMM-REGSITERED.NO-CELL AVAILABLE state. In the above example, the UE (100) may prioritize and select PLMN-1 as higher priority PLMN if UE (100) requires both S-NSSAI-1 and S-NSSAI-2. Optionally, the UE (100) may release the current N1 NAS signaling connection locally or wait for all predefined timers; e.g., TSoR-CMCI timer(s) expiry and then attempt to obtain service on a higher priority PLMN over other access type; e.g., 3GPP access type in the above example as specified in clause 4.4.3.3 of TS 23.122 by acting as if timer T that controls periodic attempts has expired

The same behavior i.e. triggering PLMN search may happen over N3GPP access when the UE (100) enters in 5GMM DEREGISTERED/5GMM-REGISTERED.NO-CELL-AVAILABLE or 5GMM DEREGISTERED LIMITED SERVICE state over 3GPP access or any other 5GMM sublayer state.

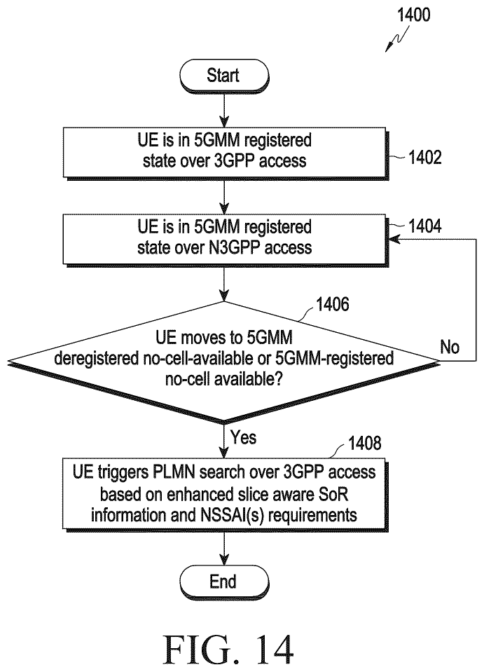

FIG. 14 is a flow chart (1400) illustrating a PLMN search triggered based on other access type 5GMM DEREGISTERED NO-CELL-AVAILABLE or 5GMM-REGSITERED.NO-CELL AVAILABLE state in the wireless network (1000), according to the embodiments as disclosed herein. The operations (1402-1408) are handled by the PLMN selection controller (140).

At 1402, the UE (100) is in the 5GMM registered state over the 3GPP access. At 1404, the UE (100) is in the 5GMM registered state over the N3GPP access. At 1406, the UE (100) determines that the UE (100) moves to a 5GMM DEREGISTERED NO-CELL-AVAILABLE or 5GMM-REGSITERED.NO-CELL AVAILABLE. In response to determining that the UE (100) moves to the 5GMM DEREGISTERED NO-CELL-AVAILABLE or 5GMM-REGSITERED.NO-CELL AVAILABLE then, at 1408, the UE (100) triggers the PLMN search over 3GPP access based on enhanced slice aware SoR information and NSSAI(s) requirements. In response to determining that the UE (100) does not move to the 5GMM DEREGISTERED NO-CELL-AVAILABLE or 5GMM-REGSITERED.NO-CELL AVAILABLE then, at 1404, the UE (100) is in the 5GMM registered state over the N3GPP access.

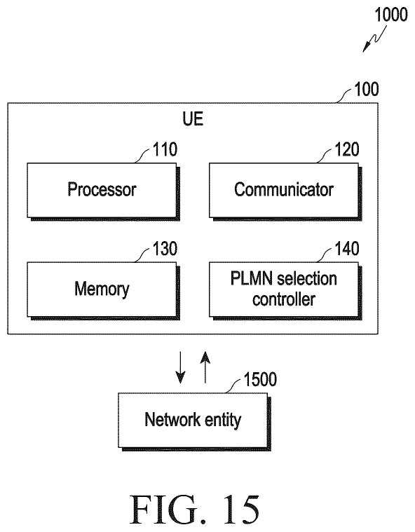

FIG. 15 shows various hardware components of the UE (100) handling the PLMN selection in the wireless network (1000), according to the embodiments as disclosed herein. The wireless network (1000) can be, for example, but not limited to a fourth generation (4G) network, a fifth generation (5G) network, an Open Radio Access Network (ORAN) or the like. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device.

In an embodiment, the UE (100) includes a processor (110), a communicator (120), a memory (130) and a PLMN selection controller (140). The processor (110) is coupled with the communicator (120), the memory (130) and the PLMN selection controller (140). In addition, the UE (100) may be implemented as a device including at least one processor controlling operations according to embodiment(s) of the present disclosure, and a transceiver (not depicted) for transmitting/receiving signals in a network. The at least one processor may include the processor (110) and the PLMN selection controller (140).

The PLMN selection controller (140) receives the slice aware SoR information from the network entity (1500). The network entity (1500) may include at least one processor and a transceiver. In an embodiment, the slice aware SoR information includes the preferred PLMN list for specific subscribed S-NSSAI in the UE subscription. The preferred PLMN list includes at least one of: the single PLMN that is known by the HPLMN (200) to support the S-NSSAI, and the list of PLMNs in the priority order. In another embodiment, the slice aware SoR information includes the S-NSSAI supported the list per PLMN. The PLMN is known by the HPLMN (200) to support the S-NSSAI, and the list of S-NSSAIs in the priority order. Each PLMN entry includes the area in which a required S-NSSAI is supported. The area can be, for example, but not limited to the TAI, the cell-ID, and the CAG-ID.

Further, the PLMN selection controller (140) determine the required network slice. In an embodiment, the required network slice is determined by using at least one of: the prioritized S-NSSAI information, information received from an upper layer of the UE (100), and usage of at least one application running in the UE (100).

Further, the PLMN selection controller (140) selects the PLMN from the plurality of PLMNs based on the priority order defined for each PLMN from the plurality of PLMNs with respect to the determined required network slice. In an embodiment, the PLMN selection controller (140) determines that the UE (100) intends to use the S-NSSAI. The S-NSSAI is not supported by the current registered PLMN. Further, the PLMN selection controller (140) utilizes the slice aware SOR information configured in the UE (100) for selecting the PLMN. Further, the PLMN selection controller (140) ignores the OPLMN list.

Further, the PLMN selection controller (140) triggers the registration procedure with the selected PLMN by sending the registration request message to the network entity (1500).

In an embodiment, the UE (100) ignores the selected PLMN when the UE (100) is in the area and the required S-NSSAI is not supported and selects a next available priority PLMN. In another embodiment, the UE (100) selects and attempt to register on the PLMN by using at least one of: the OPLMN list and the Slice aware SOR information list.

In an embodiment, after the required service is executed, the UE (100) determines to ignore the slice aware SOR information and starts using an OPLMN list to select the highest priority PLMN.

The PLMN selection controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the user equipment (100) and with external devices via one or more networks.

Although the FIG. 15 shows various hardware components of the UE (100) but it is to be understood that other embodiments are not limited thereon. In other embodiments, the UE (100) may include less or a greater number of components. Further, the labels or names of the components are used only for illustrative purpose and does not limit the scope of the invention. One or more components can be combined together to perform same or substantially similar function in the UE (100).

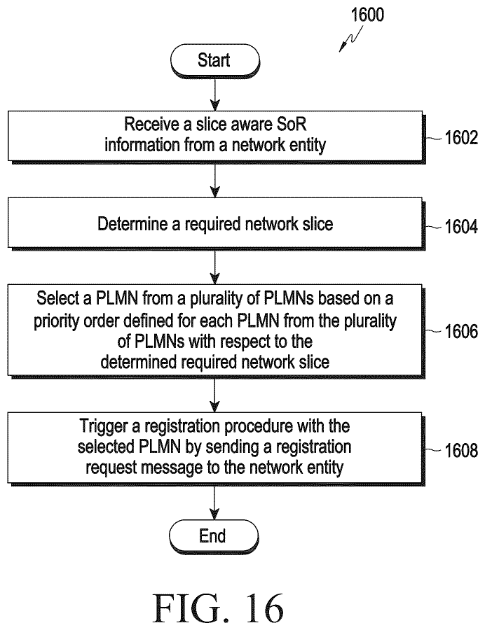

FIG. 16 is a flow chart (1600) illustrating a method for handling the PLMN selection in the wireless network (1000), according to the embodiments as disclosed herein. The operations (1602-1608) are handled by the PLMN selection controller (140).

At 1602, the method includes receiving the slice aware SoR information from the network entity (1500). At 1604, the method includes determining the required network slice. At 1606, the method includes selecting the PLMN from the plurality of PLMNs based on the priority order defined for each PLMN from the plurality of PLMNs with respect to the determined required network slice. At 1608, the method includes triggering the registration procedure with the selected PLMN by sending a registration request message to the network entity.

Based on the proposed method, the enhanced slice aware SOR information (called as Slice-based PLMN selection information) is provided to the UE (100) by the HPLMN (200) (i.e. the UDM node) based on UE subscription (i.e. based on subscription of the UE). Using the slice-based PLMN selection information, UE (100) selects a VPLMN (e.g. a PLMN selected from a plurality of PLMNs based on a priority order) which supports required S-NSSAI. The UE (100) selects the PLMN/SNPN to register on that selected network

The various actions, acts, blocks, steps, or the like in the flow charts (1400 and 1600) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1. A method for a public land mobile network (PLMN) selection in a wireless network, the method comprising:
receiving, by a user equipment (UE), slice-based PLMN selection information from a network entity of a home public land mobile network (HPLMN); and
selecting, by the UE, a visited public land mobile network (VPLMN) among a plurality of PLMNs based on a priority order defined in the slice-based PLMN selection information.

2. The method of claim 1, wherein the plurality of PLMNs are prioritized based on at least one network slice to which the UE has subscribed in the wireless network.

3. The method of claim 1, further comprising triggering, by the UE, a registration procedure with the selected VPLMN by transmitting a registration request message to the network entity.

4. The method of claim 1, wherein the slice-based PLMN selection information comprises a preferred PLMN list for specific subscribed S-NSSAI in a UE subscription, wherein the preferred PLMN list comprises at least one of: a single PLMN that is known by the HPLMN to support a network slice selection assistance information (S-NSSAI), and a list of PLMNs in the priority order.

5. The method of claim 1, wherein the slice-based PLMN selection information comprises a S-NSSAI supported a list per PLMN, wherein the VPLMN is known by a HPLMN to support a S-NSSAI, and a list of S-NSSAIs in the priority order.

6. The method of claim 1, wherein selecting, by the UE, the VPLMN among the plurality of PLMNs comprises:
determining that the UE intends to use a S-NSSAI, where the S-NSSAI is not supported by a current registered PLMN;
utilizing the slice-based PLMN selection information configured in the UE for selecting the VPLMN; and
ignoring an operator-controlled PLMN (OPLMN) list.

7. The method of claim 1, wherein each PLMN entry comprises an area in which a required S-NSSAI is supported, wherein the area comprises at least one of a tracking area identity (TAI), a cell-identifier (ID), and a closed access group ID (CAG-ID).

8. The method of claim 1, wherein the UE ignores the selected VPLMN when the UE is in an area where the required S-NSSAI is not supported and selects a next available priority PLMN.

9. The method of claim 1, wherein after a required service is executed, the UE determines to ignore the slice-based PLMN selection information and starts using an OPLMN list to select a highest priority PLMN.

10. The method of claim 1, wherein the UE selects and attempt to register on the PLMN by using at least one of: an OPLMN list and the slice-based PLMN selection information.

11. The method of claim 1, wherein the required network slice is determined by using at least one of: a prioritized S-NSSAI information, information received from an upper layer of the UE, and usage of at least one application running in the UE.

12. A user equipment (UE) in a wireless network, comprising:
a transceiver; and
at least one processor configured to:
receive, through the transceiver, slice-based PLMN selection information from a network entity of a home public land mobile network (HPLMN), and
select a visited public land mobile network (VPLMN) among a plurality of PLMNs based on a priority order defined in the slice-based PLMN selection information.

13. The UE of claim 12, wherein the plurality of PLMNs are prioritized based on at least one network slice to which the UE has subscribed in the wireless network.

14. The UE of claim 12, wherein the slice-based PLMN selection information comprises a preferred PLMN list for specific subscribed S-NSSAI in a UE subscription, wherein the preferred PLMN list comprises at least one of: a single PLMN that is known by the HPLMN to support a network slice selection assistance information (S-NSSAI), and a list of PLMNs in the priority order.

15. The UE of claim 12, wherein the slice-based PLMN selection information comprises a S-NSSAI supported a list per PLMN, wherein the VPLMN is known by a HPLMN to support a S-NSSAI, and a list of S-NSSAIs in the priority order.
